(19) United States
(12) Patent Application Publication
(10) Pub. No.: US 2011/0200771 A1
(43) Pub. Date: Aug. 18, 2011

(54) POLYMER ADDITIVES

(75) Inventor: Andrew Barclay, Stone Staffordshire (GB)

(73) Assignee: WELLS PLASTICS LIMITED, Stone Staffordshire (GB)

(21) Appl. No.: 13/123,152

(22) PCT Filed: Oct. 7, 2009
(86) PCT No.: PCT/GB09/51328

§ 371 Date: Apr. 7, 2011

(30) Foreign Application Priority Data
Oct. 8, 2008 (GB) 0818407.9

(51) Int. Cl. B32B 1/02; C08L 67/04

(52) U.S. Cl. 428/35.5; 523/124; 428/36.92

(57) ABSTRACT

A transition metal salt pro-degradant is used to enhance the biodegradability of a hydrobiodegradable polymer.

The present invention relates to additives for enhancing the degradation of polymers.

Degradability, in particular biodegradability, is a property that is increasingly valued in many polymers and polymer-containing products today.

Polymer materials are extremely useful in a wide range of products and applications, but the disposal of such materials can have significant cost, environmental and practical considerations.

Many polymer products can break down themselves over a reasonable time frame, but many are extremely stable to the extent that they remain effectively unaltered in the environment for long periods of time.

From a first aspect the present invention provides the use of a transition metal salt pro-degradant to enhance the biodegradability of a hydrobiodegradable polymer.

From a second aspect the present invention provides a masterbatch of a transition metal salt pro-degradant physically bound within a hydrobiodegradable polymer.

From a third aspect the present invention provides a hydrobiodegradable polymer or hydrobiodegradable polymer—containing material, comprising a transition metal salt pro-degradant.

The transition metal salt is a pro-degradant in the sense that it imparts oxobiodegradable characteristics to the polymer. Oxobiodegradation is the breakdown of polymer chains through transition metal catalysed oxidation to reduce the molecular weight of the chains to a level where the material can be biodegraded naturally in the environment, for example by micro-organisms.

In the past oxobiodegradation has been used on polyolefins, i.e. polymers which have numerous carbon-carbon chain linkages. Oxobiodegradation has been useful with such polymers which otherwise are extremely stable to the extent that they may take a very long time to degrade.

In contrast, the present applicant is the first to use or propose oxobiodegradation with hydrobiodegradable polymers. Hydrobiodegradable polymers easily undergo hydrolysis reactions due to the presence of functional groups so that they can be biodegraded relatively easily. They are polymers which, for example when in thin film form or when not in bulk form, undergo hydrolysis and degradation by micro-organisms. Examples of such polymers are be polyhydroxyalkanoates (PHA's).

Hydrobiodegradable polymers such as polyesters are for example easily hydrolysable due to the presence of numerous ester linkages.

However, hydrobiodegradable polymers often do not break down under reasonable conditions when they are used in certain products for example in thick films or medium- to large-gauge packaging or containers. In such cases, even though the polymers may comprise chemical structures which render them hydrobiodegradable, for example such as ester linkages, the bulk nature of the product means that they do not hydrolyse easy and therefore present considerable disposal, environmental, cost and practical disadvantages.

The present applicant is the first to utilise oxobiodegradable technology in hydrobiodegradable polymers and for the use of enhancing the degradability of such polymers.

Historically there have been two “camps” of research and development expertise: one group of companies have focused on so-called biopolymers (including hydrobiodegradable polymers) whilst another group of companies have focused on the use of additives to degrade polymers which are otherwise inherently more stable (such as polyolefins). The two groups have functioned independently and in competition with each other, and because their core technologies are different there has been little collaboration between the two. Nobody in either area has hitherto considered taking transition metal pro-degradant compounds from one area of application and translating this to the other area of hydrobiodegradable polymers; to do so exhibits inventive interdisciplinarity.

The transition metal salt pro-degradant causes the breakage of carbon-carbon bonds, and this chain scission results in materials of lower molecular weight so that they can be further broken down. One of the mechanisms by which such breakdown occurs is the Norris-type reaction.

Thus, even though oxobiodegradability has been used in the past with polymers such as polyolefins (e.g. polyethylene), thereby breaking carbon-carbon bonds in the process, the present invention uses this technology in hydrobiodegradable polymers. The present applicant recognises that when such hydrobiodegradable polymers are not thin, they can be very difficult to break down, and accordingly, oxobiodegradation is particularly useful in accelerating or facilitating such decomposition.

The types of catalyst which maybe used include transition metal salts, preferably organic salts or transition metals. Such salts include for example tartrate, stearate, oleate, citrate, and chloride amongst other possibilities.

The types of hydrobiodegradable polymers include polyesters, polyhydroxyalkanoates (PHA's) for example PHBV [poly(3-hydroxybutyrate-co-3hydroxyvalerate, which may amongst other applications be used in the production of plastic bottles and coated paper], PCL (polycaprolactone), PHB (polyhydroxybutyrate), PLA (polylactic acid) and acetylated starch, and related compounds, amongst other possibilities.

Furthermore, any polymer which has had a hydrobiodegradable property imparted to it maybe used in accordance with the present invention. The transition metal salts pro-degradants of the present invention enhance the biodegradability of such materials.

The invention is particularly advantageous where the final polymer product or polymer-containing product is greater than 20 microns thick, especially greater than 200 microns thick, because such materials may otherwise be extremely difficult to break down within reasonable time frames. Nevertheless, the present invention is also applicable with products of various thicknesses, depending for example on the environmental conditions and requirements.

Preferably, the transition metal salt pro-degradant is used in combination with other additives.

For example, free radical scavenging systems are advantageously used in combination with the transition metal salt pro-degradant additives. Such free radical scavenging systems are usually used in order to postpone the reactivity of the transition metal salt pro-degradant so that the polymer does not fall apart immediately or prematurely, and they are usually used in a sacrificial sense. Examples of possible free radical scavenging systems include hindered phenolics, thiosynergistis, phosphites, metal deactivators, monomeric, low and high molecular weight oligomeric and block oligomeric hindered amines, benzophenone absorbers, benzotriazoles, benzotriazines, and natural antioxidants such as vitamin E and other systems such as NOR's (e.g. N-hydroxycarbyloxy substituted hindered amines).

The free radical scavenger component may be used in desired amounts according to the particular application and intended lifetime of the product. Some applications require large amounts of radical scavengers to be present in order to prevent premature breakdown of the material. Other products may require particularly rapid degradation of the material. For example, it is useful for an agricultural mulch film to be broken within a short period, for example three months.

Free radical scavenging systems may be used individually or within combination with each other, and similarly not only a single particular salt of a particular transition metal may be used, but also various transition metal ions and various salts may be used singly or in combination.

Additional additives may also be used, and in many cases these may act in a synergistic sense, for example to help break down the material. Inorganic fillers (such as chalk, talc, silica, wollastonite etc.) and organic fillers (wood, starch, cotton, reclaimed cardboard, plant matter etc.) may be used in this context.

Further additional optional ingredients include enzymes, bacterial cultures, swelling agents (such as CMC for example) and sugars or other energy sources. These can all help encourage the breaking down of material, for example by permitting further reactions to take place, increasing the surface area and breaking apart the material, or acting as a food source for micro-organisms.

The additives may be physically incorporated into the polymer material so as to create a so-called “masterbatch” which is a concentrate of the transition metal salt (and any other additives) finely dispersed within polymer. The masterbatch may far example be in the form of granules.

For example, if the additives are dispersed within PHA in a masterbatch, then such masterbatch may then be combined with a far greater amount of PHA so that the overall end product is a PHA polymer with a small percentage of additives present.

The masterbatch may be created by conventional procedures. For example a single or double spiral screw device may be used in combination with heated zones so that the material may be incorporated into molten polymer which then solidifies and is then processed into the masterbatch.

As regards the compatibility between the masterbatch and the polymer into which it is intended to be incorporated, the carrier in the masterbatch may be the same as the main polymer in the polymer product. For example, the carrier in the masterbatch may be PCL where the polymer into which said masterbatch is to be incorporated is PCL, or may be PHA when the main polymer is PHA, etc. Alternatively, so-called “universal” masterbatches may be used, such as those wherein the carrier [e.g. EVA (ethylene vinyl acetate) or EMA (ethylene methyl acrylate)] is for example compatible with and intended to be incorporated into a wide variety of polymers.

Alternatively the transition metal salts and optional other additives may be incorporated directly rather than via a masterbatch.

The invention will now be described in further detail and by way of non-limiting example only, with reference to the following examples and figures in which:

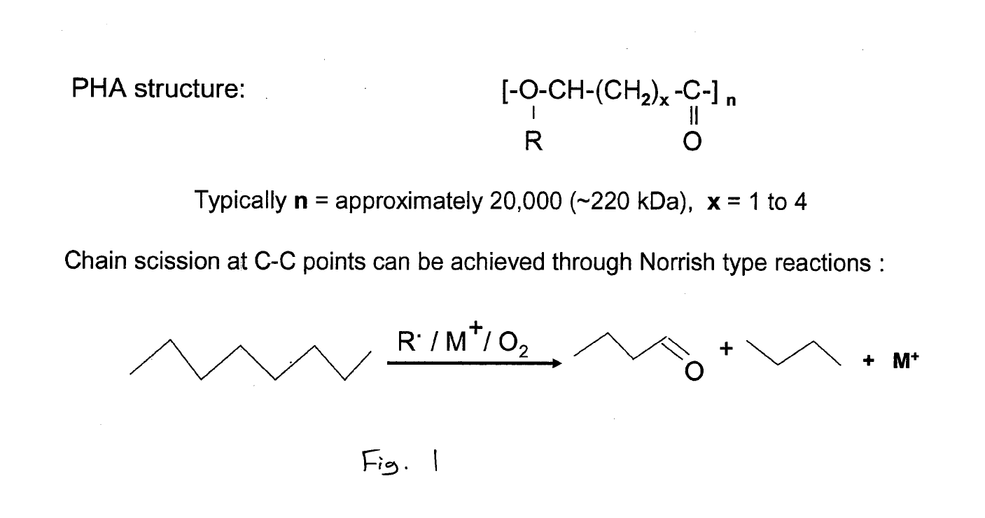

FIG. 1 shows a typical PHA structure and illustrates the chain scission of carbon-carbon bonds by oxobiodegradation;

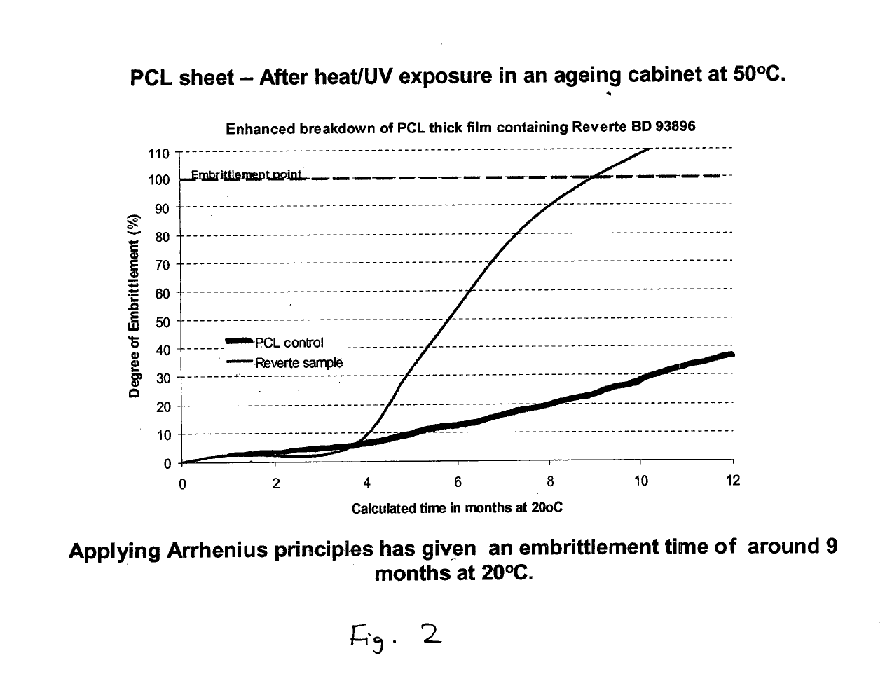

FIG. 2 shows the enhanced breakdown of PCL thick film containing an additive (“Reverte BD 93896”) in accordance with the present invention in comparison with the same film in the absence of said additive;

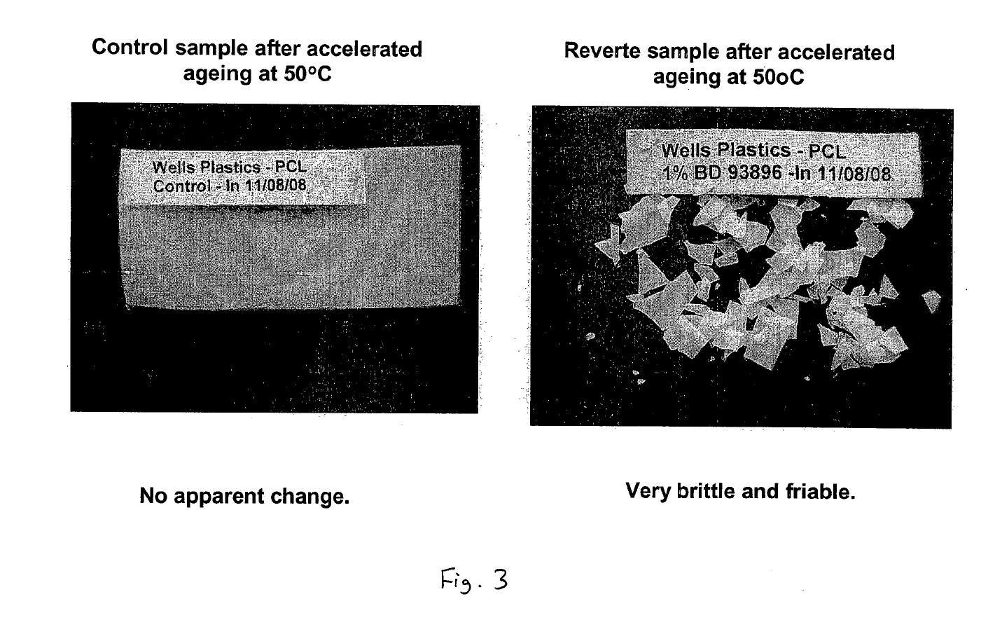

FIG. 3 compares the effect of ageing a PCL sheet in the presence and absence of a pro-degradent additive; and

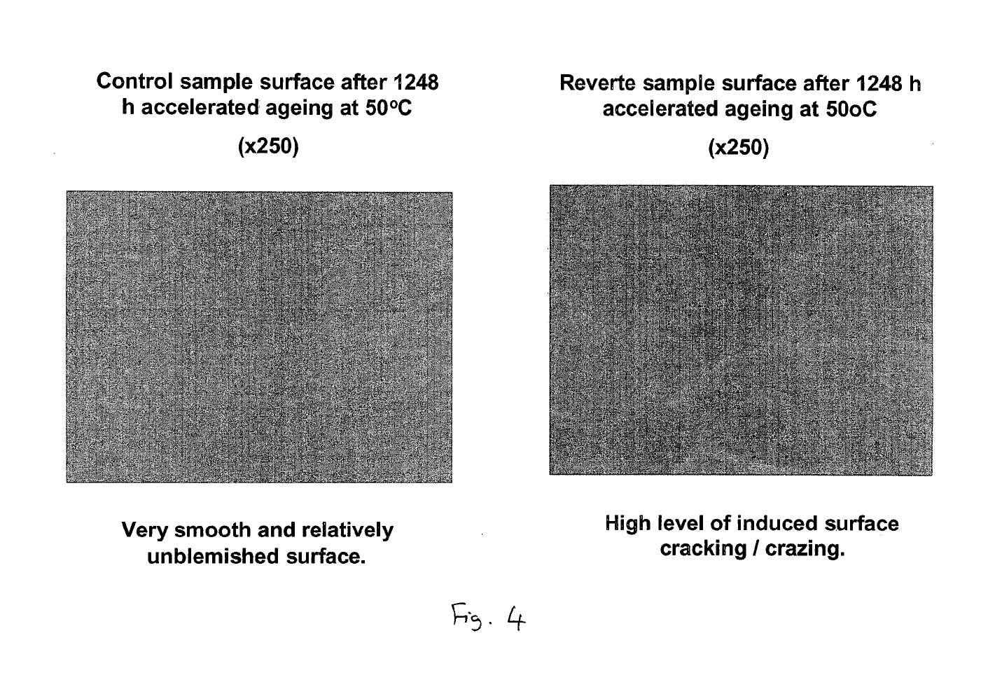

FIG. 4 shows the effect of the present additive at magnified scale.

Thus, thicker section polymers present difficulty to microorganisms that may wish to break them down and utilise them as a carbon source. This is because their macromolecular structure, intrinsic hydrophobicity and daunting physical structure present barriers to rapid biodegredation.

The present invention meets the challenge posed by thicker section products, in particular view of the requirements of industrial composters, in order to break down the polymers' molecular weight, increase hydrophilicity and increase specific surface area to enable or facilitate subsequent biodegradation.

Hydrobiodegradable polymers e.g. polyesters such as for example polyhydroxyalkanoates (PHA's) can be manufactured from renewable or oil based resources.

Hydrobiodegradable polymers are intrinsically biodegradable and can meet the exacting requirements of composting specifications such as ASTM D6400 and EN 13432. However, when presented in larger sections, or in more arid composting conditions, products can fail to hydrolyse, and subsequently biodegrade, at a rate acceptable to industrial composting facilities.

The present invention provides a method of introducing a controlled reduction in the molecular weight of biopolymers, programmed to commence after disposal, thereby giving the following benefits:

1. a drastic reduction in physical properties leading to ready fragmentation.

2. an increase in hydrophilicity.

3. increased specific surface area to enhance subsequent hydrobiodegredation.

The present invention provides polymer-specific products to realise these benefits.

The following definition from the website of Rapra (www.rapra.net) may further help with understanding some concepts in relation to the present invention: “Two closely linked mechanisms of degradation that are frequently confused with biodegradation are Hydro-degradation (degradation via hydrolysis) and Photo-degradation (degradation via photolysis). Since both mechanisms are often subsequently followed by microbial degradation, confusion of definition frequently occurs. Polymers that do not degrade via biological mechanisms should be termed ‘bioerodable’. Polymers that are initiated by hydrolysis or photolysis and are subsequently followed by microbial or enzymatic attack should be termed hydro-biodegradable or photo-biodegradable respectively.”

FIG. 1 shows a typical PHA structure. Oxidative degradation causes chain scission at C—C bonds. The metal ion catalyst is regenerated allowing reaction to continue and chain lengths to become progressively smaller. When the molecular weight is sufficiently reduced, fragmentation, hydrolysis and subsequent break down, for example by microbial attack, are promoted.

The present invention provides a metal ion pro-degradant package to controllably reduce the polymer chain length but nevertheless give a clearly defined “dwell time”; and a photoinitiation package to protect the product from premature breakdown before disposal. Furthermore, the product is environmentally friendly and does not have toxic components or products. The components pass EC and FDA food contact specifications.

FIG. 2 shows the dramatic effect of the metal iron prodegradent in enhancing the brittle nature of a PCL sheet. This is further shown in FIGS. 3 and 4, wherein the presence of the additive significantly enhances the breakdown.

The additives impart oxo-biodegradable characteristics to films and extrusions, allow high levels of control and processing under standard conditions, and maintain excellent physical and optical properties in blown and cast film. The metal ion pro-degradant imparts a photodegradable and thermodegradable property to the polymers. The secondary stage biodegredation promoter utilises a carefully selected reaction rate modifier to control the timing and triggering of the oxo-biodegredation.

when the additive is incorporated via a masterbatch the masterbatch typically takes the form of small plastic pellets for incorporation into polymer products. Initially the oxo-degradation of the polymer chains is catalysed and the growth of microbial colonies is expedited in the second biodegradation stage. The initial chain scission (degradation) of the polymer chain causes a serial reduction in polymer molecular weight which ultimately results in an acute enbrittlement, micro-fragmentation and bio-digestion. Oxo-degradation may for example cause the formation of carbonyl group at the point of every scission.

The product may be used in all types of film, for example household rubbish bags, food packaging, supermarket bags, bubble wrap, nappy sacks, magazines and many others.

The product may also be used in agricultural films. The use of an agricultural mulch film can transform the growing process with higher yields. However, once the season is over the recovery of the film can be extremely problematic. The use of the additive can improve the process by eliminating or reducing the need to remove the film at the end of the season. The film can be formulated to break down in a pre-programmed manner under defined conditions. Once the film has micro-fragmented the small fragments can be ploughed into the ground without having to remove the film from the ground. Once the molecular weight of the fragments is low enough biodigestion of the film can occur in the soil.

Disposable food trays are used all over the world and there is concern about their impact on the environment and the product behaviour in the waste stream. In addition they can often be discarded causing an unsightly littering problem. Treatment with food-safe additive in accordance with the present invention can greatly reduce this problem and ultimately aid the biodigestion of the plastic. After the disposable tray is discarded into the waste stream it will begin embrittle and will rapidly fragment. In a greatly reduced period of time compared to untreated plastic the tray will no longer be a littering hazard and the fragment will ultimately become available for biodigestion.

1. A method of increasing the biodegradability of a hydrobiodegradable polymer comprising adding to said polymer a transition metal salt additive composition that accelerates the hydrobiodegradation of said polymer in an amount that is effective to increase said hydrobiodegradation.

2. A composition comprising a transition metal salt additive for a hydrobiodegradable polymer that accelerates the hydrobiodegradation thereof, wherein said additive is physically bound within a hydrobiodegradable polymer.

3. A product formed at least in part from a hydrobiodegradable polymer composition comprising the transition metal salt additive composition of claim 2 in an amount effective to accelerate the hydrobiodegradation of said polymer.

4. The method of claim 1 wherein the hydrobiodegradable polymer is a polyhydroxyalkanoate.

5. The method of claim 1, wherein the salt is selected from the group consisting of tartrate, stearate, oleate, citrate, and chloride salts.

6. The method of claim 1, wherein the additive composition further comprises a free radical scavenging system.

7. The method of claim 1, wherein the additive composition further comprises one or more inorganic or organic fillers.

8. The method of claim 1, wherein the additive composition further comprises one or more compounds selected from the group consisting of enzymes, bacterial cultures, swelling agents and sources of energy for bacterial cultures.

9. The product of claim 3 characterized in that the product is a bottle, container, package, film, disposable rubbish bag, drinking cup, item of cutlery, pen, food container, food packaging, single use item or disposable item.

10. The product of claim 9 which is a bottle.

11. The composition of claim 2, wherein said hydrobiodegradable polymer is a polyhydroxyalkanoate.

12. The composition of claim 2, wherein said salt is selected from the group consisting of tartrate, stearate, oleate, citrate and chloride salts.

13. The composition of claim 2, further comprising a free radical scavenging system.

14. The composition of claim 2, further comprising one or more inorganic or organic fillers.

15. The composition of claim 2, further comprising one or more compounds selected from the group consisting of enzymes, bacterial cultures, swelling agents and sources of energy for bacterial cultures.

16. The composition of claim 2, comprising a masterbatch quantity of said transition metal salt.

17. The product of claim 3, wherein said hydrobiodegradable polymer is a polyhydroxyalkanoate.

18. The product of claim 3, wherein said salt is selected from the group consisting of tartrate, stearate, oleate, citrate and chloride salts.

19. The product of claim 3, further comprising a free radical scavenging system.

20. The product of claim 2, further comprising one or more inorganic or organic fillers.
